(19) United States
(12) Patent Application Publication
(10) Pub. No.: US 2014/0339062 A1
(43) Pub. Date: Nov. 20, 2014

(54) INTEGRATED HINGE TOUCH SENSOR

(71) Applicant: CIRQUE CORPORATION, Salt Lake City, UT (US)

(72) Inventor: Paul H. Glad, Taylorsville, UT (US)

(73) Assignee: CIRQUE CORPORATION, Salt Lake City, UT (US)

(21) Appl. No.: 14/278,706

(22) Filed: May 15, 2014

Related U.S. Application Data
(60) Provisional application No. 61/823,778, filed on May 15, 2013.

(51) Int. Cl. G06F 3/02

(52) U.S. Cl. CPC G06F 3/0202
USPC 200/343; 29/622

(57) ABSTRACT

A system and method for providing a button-less touch sensor that uses a flexible material or PCB that is either integral to the touch sensor or is added after manufacture, the flexible material functioning as an integral hinge mechanism of the touch sensor that does not interfere with near field communications of an NFC antenna.

### BACKGROUND OF THE INVENTION

1. Field of the Invention

This invention relates generally to a button-less design of a touch sensor, the touch sensor incorporating an integrated hinge as part of the touch sensor, and a mechanical switch beneath the touch sensor that is activated by pressing anywhere on the touch sensor.

2. Description of Related Art

There are several designs for capacitance sensitive touch sensors. It is useful to examine the underlying technology to better understand how any capacitance sensitive touchpad can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Using an equation that compares the magnitude of the two signals measured then performs pointing object position determination.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention. The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing.

The state of the art in providing a mechanical switch underneath a touch sensor such as a touchpad may rely on a touch sensor having a metal support bracket and a metal hinge mechanism coupled to the metal support bracket. These metallic structures may be expensive to include in a touch sensor design.

Possibly more important is the effect that a metal support bracket may have on the use of a near-field communication (NFC) antenna in close proximity to a touch sensor. An NFC antenna used in combination with a touch sensor may be sensitive to the interference that may be caused by a metal support bracket and the metallic hinge mechanism. Accordingly, it would be an advantage to be able to provide a mechanical switch that does not rely on a touch sensor having a metal support bracket or a metal hinge mechanism.

### BRIEF SUMMARY OF THE INVENTION

In a preferred embodiment, the present invention is a system and method for providing a button-less touch sensor that uses a flexible material or PCB that is either integral to the touch sensor or is added after manufacture, the flexible material functioning as an integral hinge mechanism of the touch sensor that does not interfere with near field communications of an NFC antenna.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which can be operated in accordance with the principles of the present invention.

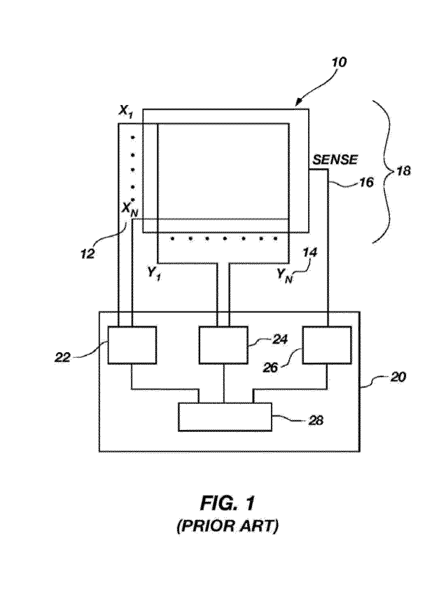

FIG. 2 is a top view of a first embodiment of a touch sensor using a flexible material for integral hinge tabs that are integral to the touch sensor.

FIG. 3 is a top view of an alternative embodiment of the touch sensor with the flexible material for integral hinge tabs disposed in a different location of the touch sensor.

FIG. 4 is a top view of the first embodiment shown in FIG. 2 with a housing that is coupled to the two integral hinge tabs made of the flexible material.

FIG. 5 is a cut-away profile view of a housing and a touch sensor.

FIG. 6 is a close-up view of the cut-away profile view of FIG. 5.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It should be understood that use of the term “touch sensor” throughout this document may be used interchangeably with “capacitive touch sensor”, “touch panel”, “touchpad” and “touch screen”. In addition, the term “portable electronic appliance” may be used interchangeably with the “mobile telephone”, “smart phone” and “tablet computer”.

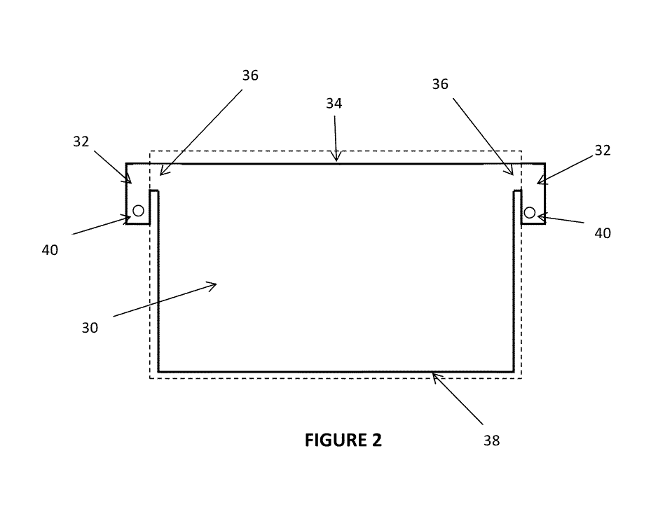

In a first embodiment of the present invention, FIG. 2 is a top schematic view of a touch sensor 30. The touch sensor 30 may be defined as a substrate on which a grid of X and Y electrodes may be disposed. The X and Y electrodes may then be connected to a touch controller circuit which may send and receive signals from the X and Y electrodes in order to detect and track objects on the touch sensor 30. The touch controller circuit may be one or more integrated circuits that are disposed on a separate substrate or on a side of the touch sensor 30 that is opposite the X and Y electrodes.

In this embodiment, two integral hinge tabs 32 are shown attached to a fixed edge 34 of the touch sensor 30. The fixed edge 34 provides a hinge function wherein the touch sensor 30 pivots along the fixed edge. The two integral hinge tabs 32 may be anchored to a housing (not shown) using the attachment holes 40. If the two integral hinge tabs 32 are anchored to the housing, the touch sensor 30 may be free to flex at the joints 36 between the two integral hinge tabs and the touch sensor.

In this first embodiment, the touch sensor 30 may be made of a single material that may be flexible at the joints 36. Alternatively, the touch sensor 30 may be made of more than one material that may be flexible at the joints 36.

It is another feature of the first embodiment that the substrate may be one or more materials that do not interfere with operation of an NFC antenna.

If the touch sensor 30 flexes at the joints 36, the opposite edge or moving edge 38 of the touch sensor is free to pivot in a direction that is slightly up from the page or down toward the page.

Another feature of the first embodiment shown in FIG. 2 is that the two integral hinge tabs 32 may be manufactured as an integral part of the substrate. The substrate may be manufactured from printed circuit board (PCB) material that may also be used as the substrate of the touch sensor 30. In other words, as the PCB material is being cut, the two integral hinge tabs 32 may be included as one or more layers of the PCB material.

The exact dimensions are not limited to a size shown in FIG. 2. The size of the two integral hinge tabs 32 are for illustration purposes only and should not be considered as limiting the invention. In addition, the attachment holes 40 are optional features. Accordingly, another means of attaching the touch sensor 30 to the housing may be used in place or in addition to the holes 40. The integral hinge tabs 32 may be substantially co-planar with the touch sensor 30.

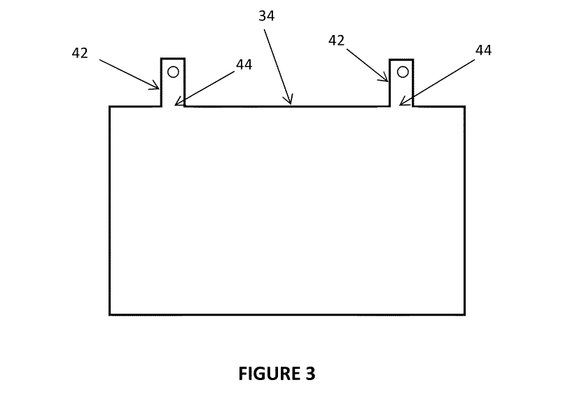

FIG. 3 is another embodiment of the present invention which shows an alternative placement of the integral hinge tabs. In FIG. 3, the touch sensor 30 provides two top edge integral hinge tabs 42 disposed along the top of the fixed edge 34 of the touch sensor and not at the sides of the fixed edge. The touch sensor 30 may flex at the joints 44 because of the inherent flexibility of the material used as a substrate for the touch sensor in order to achieve the desired movement of the touch sensor. It should be understood that more than one top edge tab 42 may be used along the fixed edge 34. Ideally the top edge integral hinge tabs 42 are not too wide so that they may flex to a desired degree. Alternatively, a single wider top edge integral hinge tab 42 may also be used in place of multiple top edge tabs that are not as wide. The exact placement of multiple top edge integral hinge tabs 42 should not be considered as limited to the placement shown in FIG. 3, and is for illustration purposes only.

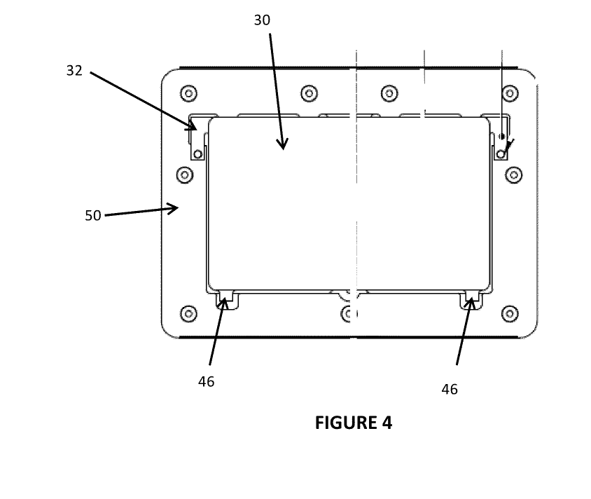

FIG. 4 is another top view of the first embodiment wherein the touch sensor 32 may be attached to a housing 50. This is only an example of a stand-alone housing 50 and should not be considered as limiting any of the housings that may be connected to the touch sensor 30.

Another feature that is shown in FIG. 4 is the use of stop tabs 46 that may prevent the touch sensor 30 from flexing too far into a depression underneath the touch sensor in the housing 50. The location, size and shape of the stop tabs 46 may be changed and still not depart from the inventive aspects of the present invention of providing a means for halting movement of the touch sensor 30 past a desired degree of flexing. The stop tabs 46 may be substantially co-planar with the touch sensor 30.

In an alternative embodiment, the stop tabs 46 may also be disposed on an edge of the touch sensor 30 that is perpendicular to the moving edge 38. What is important is that the stop tabs 46 be capable of stopping movement of the moving edge 38 after a certain amount of movement is enabled.

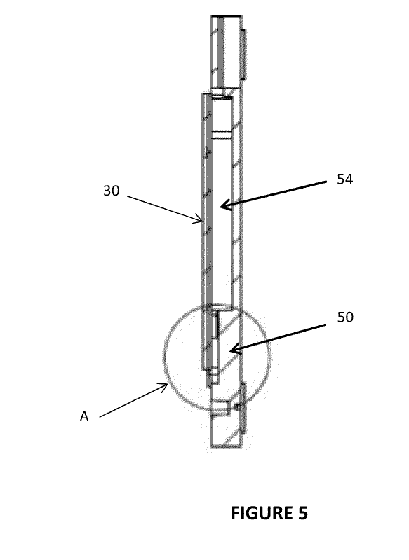

FIG. 5 is a cut-away profile view of the touch sensor 30 disposed in the housing 50. A depression 54 is shown as being underneath the touch sensor 30.

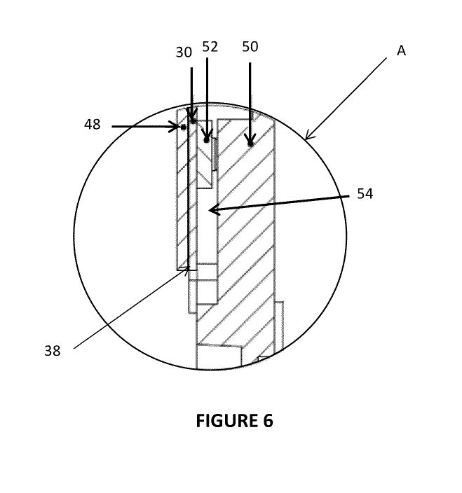

FIG. 6 is an expanded view of circle A of the cut-away profile view of FIG. 5. This figure shows several features not previously shown. A first feature is an overlay 48 disposed on top of the touch sensor 30. The overlay 48 is optional but is useful to show information such as the outline of buttons or specific touch regions, or for providing additional protection for the X and Y electrodes disposed on the touch sensor 30.

Another feature shown in FIG. 6 is a button or switch 52 disposed under the moving edge 38 of the touch sensor 30. The switch 52 is disposed in the depression 54 underneath the touch sensor 30, and may be actuated by pressing on the touch sensor so that the moving edge 38 pivots down into the depression.

The depth and shape of the depression 54 should not be considered a limiting factor of the invention, and the depression is shown for illustration purposes only.

It should also be understood that combining the functions of a metal support and hinge into the touch sensor 30 by creating an integral hinge using the integral hinge tabs 32 or 42 makes the touch sensor simpler to assemble. For example, assembly costs may be reduced by eliminating assembly steps that would otherwise require adding a metal support and hinge onto the touch sensor 30, reducing labor and eliminating mechanical components.

Removing the metal support and hinge components may reduce thickness of the touch sensor 30 and may also reduce overall weight. A reduction in thickness and weight may enable the touch sensor 30 with an integrated hinge to be more compatible with leading edge laptop designs. Additionally, eliminating the need for a metal support bracket allows more of the underside of the touch sensor 30 to be used for component placement, such as the touch controller circuit.

In an alternative embodiment of the invention, an existing touch sensor without integral hinge tabs may be modified to include tabs. For example, a flexible material may be attached to the touch sensor 30. The flexible material may or may not be approximately a same size as the touch sensor 30, but may also include the integral hinge tabs. The flexible material may be attached to an underside of the touch sensor 30 using an adhesive or other appropriate attaching mechanism. The flexible material may be any material that provides the flexibility needed for the integral hinge tabs to function.

Manufacturing the touch sensor 30 using a flexible substrate material in order to have integral hinge tabs 32 or 42, or adding a flexible material with the integral hinge tabs to an existing touch sensor may be done using a material that may not substantially interfere with radio frequency functions. The flexible material may be comprised of a material that may not substantially interfere with operation of a radio frequency antenna such as an NFC antenna. For example, the flexible material may be comprised of FR4 or a plastic material.

By removing a metal support bracket, this action may also enable prior art touch sensors to eliminate interference between the metal structure and a radiated signal from an NFC antenna. Thus, the removal of a metal support enables ferrite material to be added to any part of the touch sensor 30 without interference with other metal support components.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for providing at least one integral hinge tab on a touch sensor to enable actuation of a switch by the touch sensor, said method comprising:
1) providing a touch sensor on a flexible material, the touch sensor having a fixed edge and a moving edge, the flexible material including at least one integral hinge disposed adjacent to the fixed edge; and
2) disposing a switch under the touch sensor in proximity of the moving edge, wherein pressing on the touch sensor causes the touch sensor to pivot at the at least one integral hinge and to move at the moving edge to actuate the switch.

2. The method as defined in claim 1 wherein the method further comprises using two integral hinges, the two integral hinges disposed adjacent to the fixed edge, on opposite edges of the touch sensor, substantially co-planar with the touch sensor, extending parallel to the fixed edge and away from the touch sensor.

3. The method as defined in claim 1 wherein the method further comprises making the at least one integral hinge attached to and perpendicular to the fixed edge but substantially co-planar with the touch sensor.

4. The method as defined in claim 1 wherein the method further comprises providing at least one stop tab, the at least one stop tab being coupled to the moving edge of the touch sensor, disposed substantially co-planar with the touch sensor and extending away from the touch sensor.

5. The method as defined in claim 1 wherein the flexible material further comprises a material that does not substantially interfere with operation of a radio frequency antenna.

6. A method for providing at least one integral hinge tab on a touch sensor to enable actuation of a switch by the touch sensor, said method comprising:
1) providing a touch sensor that is not manufactured with at least one integral hinge;
2) providing at least one integral hinge on a flexible material, the flexible material including at least one integral hinge in proximity of a fixed edge;
3) coupling the flexible material with the at least one integral hinge to the touch sensor in order to enable the at least one hinge to provide a hinge function to the touch sensor at a fixed edge of the touch sensor; and
4) disposing a switch under the touch sensor in proximity of a moving edge, wherein pressing on the touch sensor causes the touch sensor to pivot at the fixed edge and move at the moving edge to actuate the switch.

7. The method as defined in claim 6 wherein the method further comprises making the at least one integral hinge from two integral hinges, the two integral hinges disposed opposite each other, disposed adjacent to the fixed edge, extending parallel to the fixed edge and away from the touch sensor.

8. The method as defined in claim 6 wherein the method further comprises making the at least one integral hinge attached to and perpendicular to the fixed edge and extending away from the touch sensor.

9. The method as defined in claim 6 wherein the method further comprises providing at least one stop tab, the at least one stop tab being coupled to the moving edge of the touch sensor and extending away from the touch sensor.

10. The method as defined in claim 6 wherein the flexible material further comprises a material that does not substantially interfere with operation of a radio frequency antenna.

11. A system for providing at least one integral hinge tab on a touch sensor to enable actuation of a switch by the touch sensor, said system comprised of:
a touch sensor on a flexible material, the flexible material including at least one integral hinge in proximity of a fixed edge; and
a switch under the touch sensor in proximity of a moving edge, wherein pressing on the touch sensor causes the touch sensor to pivot at the fixed edge and move at the moving edge to actuate the switch.

12. The system as defined in claim 11 wherein the system is further comprised of two integral hinges, the two integral hinges disposed opposite each other, disposed adjacent to the fixed edge, extending parallel to the fixed edge and away from the touch sensor.

13. The system as defined in claim 11 wherein the system is further comprised of at least one integral hinge attached to and perpendicular to the fixed edge and extending away from the touch sensor.

14. The system as defined in claim 11 wherein the system is further comprised of at least one stop tab, the at least one stop tab being coupled to the moving edge of the touch sensor and extending away from the touch sensor.

15. The method as defined in claim 11 wherein the flexible material is further comprised of a material that does not substantially interfere with operation of a radio frequency antenna.

16. A system for providing at least one integral hinge tab on a touch sensor to enable actuation of a switch by the touch sensor, said system comprised of:
a touch sensor that is not manufactured with at least one integral hinge;
at least one integral hinge on a flexible material, the flexible material including at least one integral hinge in proximity of a fixed edge;
a switch under the touch sensor in proximity of a moving edge, wherein pressing on the touch sensor causes the touch sensor to pivot at the fixed edge and move at the moving edge to actuate the switch.

17. The system as defined in claim 16 wherein the system is further comprised of two integral hinges, the two integral hinges disposed opposite each other, disposed adjacent to the fixed edge, extending parallel to the fixed edge and away from the touch sensor.

18. The system as defined in claim 16 wherein the system is further comprised of at least one integral hinge attached to and perpendicular to the fixed edge and extending away from the touch sensor.

19. The system as defined in claim 16 wherein the system is further comprised of at least one stop tab, the at least one stop tab being coupled to the moving edge of the touch sensor and extending away from the touch sensor.

20. The method as defined in claim 16 wherein the flexible material is further comprised of a material that does not substantially interfere with operation of a radio frequency antenna.
